(19) United States
(12) Patent Application Publication
(10) Pub. No.: US 2026/0359671 A1
(43) Pub. Date: Nov. 12, 2026

(54) Memory-Governed Admissibility System for Multi-Modal Communication Participation Across Heterogeneous Carriers

(71) Applicant: Xinxin Shan, Surrey (CA)

(72) Inventor: Xinxin Shan, Surrey (CA)

(73) Assignee: LED Smart Inc, Surrey, BC (CA)

(21) Appl. No.: 19/675,328

(22) Filed: May 12, 2026

(51) Int. Cl. G06N 5/022

(52) U.S. Cl. CPC G06N 5/022

(57) ABSTRACT

A system exists in which representations originating from heterogeneous communication carriers correspond to governed fact expression structures and to structured memory entities only upon admissibility correspondence within a system memory domain. The system memory domain defines admissibility conditions, relational states, and structural participation forms independent of communication-layer properties. System behavior corresponds only to admissible structural participation of structured memory entities and does not correspond to communication outcome, routing, protocol selection, or transmission success. Cross-carrier correspondence exists as a structural validation condition. Representations lacking admissibility correspondence do not exist as participating structures, thereby defining behavior as a function of admissible structural participation within memory, independent of communication-layer variability and carrier-originated conditions, wherein the system behavior corresponds to physical device control, signal transmission initiation, measurable system state change, or interaction with an external physical system.

### CROSS-REFERENCE TO RELATED APPLICATIONS

This application is not based on and does not claim priority to any previously filed application. Concepts described herein relate to memory-governed system architectures, representation correspondence, identity continuity, cross-carrier participation structures, and admissibility-based behavioral constitution.

### PRIOR ART

The references listed below correspond to publicly available patent documents.

The inclusion of any reference herein is not an admission that such reference is material to patentability, is relevant to the claimed subject matter, or constitutes prior art against the present disclosure.

None of the listed references is believed to disclose or render obvious a system in which system behavior is constituted solely through admissible structural participation within a system memory domain.

US PATENT DOCUMENTS

| | |
|---|---|
| U.S. Pat. No. 8,249,042 B2 | August 2012 Sparr et al. |
| US 2005/0201340 A1 | September 2005 Wang et al. |
| U.S. Pat. No. 7,336,642 B2 | February 2008 Rich et al. |
| U.S. Pat. No. 10,383,069 B2 | August 2019 Nguyen-Dang |
| U.S. Pat. No. 8,532,023 B2 | September 2013 Buddhikot et al. |
| U.S. Pat. No. 8,233,905 B2 | July 2012 Vaswani et al. |
| U.S. Pat. No. 11,265,799 B2 | March 2022 Tao et al. |
| U.S. Pat. No. 10,728,751 B2 | July 2020 Lahteenmaki et al. |
| U.S. Pat. No. 10,878,441 B2 | December 2020 Hollinger et al. |
| U.S. Pat. No. 10,917,642 B2 | February 2021 Tabatabai et al. |
| U.S. Pat. No. 11,131,992 B2 | September 2021 Du et al. |
| U.S. Pat. No. 10,537,996 B2 | January 2020 Egerstedt et al. |
| U.S. Pat. No. 10,007,513 B2 | June 2018 Malladi et al. |
| U.S. Pat. No. 10,179,588 B2 | January 2019 Takamatsu |
| U.S. Pat. No. 11,348,073 B2 | May 2022 Alvarez |
| U.S. Pat. No. 10,673,538 B2 | June 2020 Pressnitzer et al. |
| U.S. Pat. No. 9,882,833 B2 | January 2018 Mcbride et al. |
| U.S. Pat. No. 10,705,808 B2 | July 2020 Chiosi et al. |
| U.S. Pat. No. 11,348,597 B2 | May 2022 Hill et al. |
| U.S. Pat. No. 10,305,803 B2 | May 2019 Fredette et al. |

### BACKGROUND OF THE INVENTION

In communication environments utilizing heterogeneous carriers, system behavior is commonly associated with communication outcome, signal quality, routing determination, or protocol selection. Such association lacks a structural mechanism by which representations derived from communication correspond to admissibility conditions for participation in system behavior. Under degraded, asynchronous, or adversarial conditions, representations may lack correspondence to verifiable structural relationships, while remaining associated with communication-layer properties. In absence of a system memory domain defining admissibility conditions, relational states, and structural participation forms, behavior may be linked to representations that do not correspond to admissible structural participation. This results in dependency on communication-layer properties rather than existence conditions defined within memory.

### SUMMARY OF THE INVENTION

A system exists in which representations originating from heterogeneous communication carriers correspond to governed fact expression structures and to structured memory entities only upon admissibility correspondence within a system memory domain. The system memory domain defines admissibility conditions, relational states, structural participation forms, and memory-formed constraints as a structural boundary independent of communication-layer properties. System behavior corresponds only to admissible structural participation of structured memory entities and does not correspond to communication outcome, routing, protocol selection, or transmission success. Cross-carrier correspondence exists as a structural validation condition independent of carrier characteristics. Representations lacking admissibility correspondence do not exist as participating structures. The system may be deployed in a physical environment including, without limitation, an underwater environment.

### BRIEF DESCRIPTION OF DRAWINGS

FIG. 1—Core Structural Domain

FIG. 2—Governed Representation and Memory Entity Subdomain

FIG. 3—Admissibility Correspondence Subdomain

FIG. 4—Behavioral Constitution and System State Subdomain

### DETAILED DESCRIPTION OF THE INVENTION

The following figures define structural relationships of a memory-governed system in which system behavior exists only upon admissible structural participation of structured memory entities within a system memory domain. All elements represent structural existence, admissibility conditioning, representation correspondence, memory participation, and behavioral constitution relationships only, and do not represent sequence, processing, routing, optimization, artificial intelligence decision-making, or control determination. All elements constitute a non-separable unified system. The underwater environment corresponds to a non-limiting deployment context and does not restrict the system to underwater operation unless expressly recited in a dependent claim.

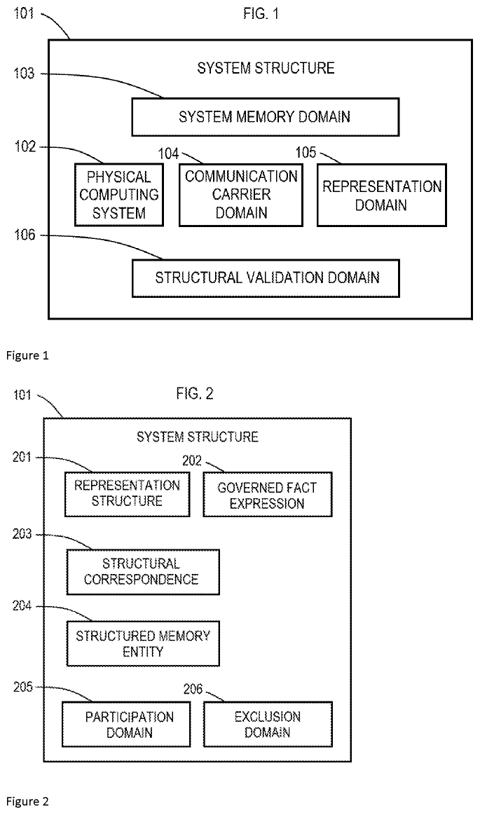

### FIG. 1—Core Structural Domain

A system structure 101 exists as a unified structural domain defining a base structural domain within which all subsequent structural subdomains exist.

A physical computing system 102 exists within said system structure 101, said physical computing system comprising at least one processor and at least one memory.

A system memory domain 103 exists within said system structure 101 as a structured portion of said memory, wherein admissibility conditions, structural participation forms, and memory-formed boundary constraints exist.

A communication carrier domain 104 exists within said system structure 101 corresponding to heterogeneous carriers, wherein underwater communication carriers constitute a non-limiting subset including acoustic, optical, and electromagnetic communication.

A representation domain 105 exists within said system structure 101 corresponding to carrier-originated representations.

A structural validation domain 106 exists within said system structure 101 corresponding to admissibility conditioning.

All domains 101-106 coexist as structural relations without sequence, transformation, or communication determination.

### FIG. 2—Governed Representation and Memory Entity Subdomain

A representation structure 201 exists as a structural subdomain within said system structure 101.

A governed fact expression structure 202 exists as a structural subdomain within said system structure 101, corresponding to governed fact expression structures structurally coexisting with said representation structure 201 under admissibility conditions within said system memory domain 103.

A structural correspondence domain 203 exists as a structural subdomain within said system structure 101, corresponding to structural association between representation structure 201 and governed fact expression structure 202 independent of carrier type, signal format, naming, modeling, or algorithmic interpretation.

A structured memory entity domain 204 exists as a structural subdomain within said system structure 101, corresponding to admissibility-conditioned entities capable of participation within said system memory domain 103.

A participation domain 205 exists as a structural subdomain within said system structure 101, corresponding to admissible inclusion of structured memory entities within said system memory domain 103.

An exclusion domain 206 exists as a structural subdomain within said system structure 101, corresponding to structural exclusion of representations or entities lacking admissibility correspondence.

All domains 201-206 coexist without transformation, processing, or sequencing implication.

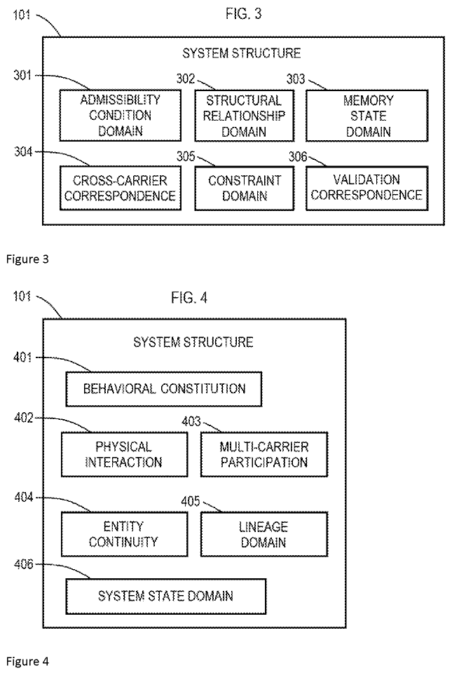

### FIG. 3—Admissibility Correspondence Subdomain

An admissibility condition domain 301 exists as a structural subdomain within said system structure 101.

A structural relationship domain 302 exists as a structural subdomain within said system structure 101 corresponding to stored structural relationships within said system memory domain 103.

A memory state domain 303 exists as a structural subdomain within said system structure 101 corresponding to validated memory states.

A cross-carrier correspondence domain 304 exists as a structural subdomain within said system structure 101 corresponding to representation consistency across heterogeneous carriers.

A constraint domain 305 exists as a structural subdomain within said system structure 101 corresponding to memory-formed structural constraints and boundary conditions.

A validation correspondence domain 306 exists as a structural subdomain within said system structure 101 corresponding to admissibility-based structural correspondence of structured memory entities.

Domains 301-306 collectively define admissibility correspondence within said system memory domain 103 without implying evaluation sequence, decision logic, or procedural determination.

### FIG. 4—Behavioral Constitution and System State Subdomain

A behavioral constitution domain 401 exists as a structural subdomain within said system structure 101 corresponding to system behavior constituted only upon admissible structural participation of structured memory entities within said system memory domain 103.

A physical interaction domain 402 exists as a structural subdomain within said system structure 101 corresponding to physical device control, signal transmission initiation, measurable system state change, or interaction with an external physical system.

A multi-carrier participation domain 403 exists as a structural subdomain within said system structure 101 corresponding to participation across heterogeneous carriers without hierarchical prioritization, routing dependency, or protocol determination.

A structured entity continuity domain 404 exists as a structural subdomain within said system structure 101 corresponding to persistence of structured memory entities independent of communication carrier conditions.

A lineage domain 405 exists as a structural subdomain within said system structure 101 corresponding to preservation of participation history, structural continuity, admissibility history, and reconstructable consistency within said system memory domain across time.

A system state domain 406 exists as a structural subdomain within said system structure 101 corresponding to admissibility-governed existence within a physical system.

All domains 401-406 coexist as structural domains without control flow, execution sequence, or operational ordering.

The following description defines structural relationships of a memory-governed system in which system behavior exists only upon admissible structural participation of structured memory entities within a system memory domain. All described elements correspond to structural existence, admissibility conditioning, representation correspondence, memory participation, and behavioral constitution relationships only, and do not correspond to execution sequence, procedural steps, transformation processes, routing, optimization, artificial intelligence decision-making, or control determination. All described elements constitute a non-separable unified system, and no individual component, carrier, representation, or condition may independently constitute system behavior outside admissible structural participation within said system memory domain.

System behavior is not determined by communication outcome, transmission success, signal quality, routing mechanism, protocol selection, or any carrier-originated condition. Representations originating from underwater communication carriers exist only as candidate structural constructs and do not constitute system behavior in absence of admissibility correspondence. Admissibility correspondence exists solely within the system memory domain as a result of structural relationships, validated memory states, cross-carrier correspondence, and memory-formed constraints. All external systems, including communication systems, artificial intelligence systems, routing mechanisms, or protocol implementations, exist only as representation sources or supporting tools and do not determine or constitute system behavior. The underwater environment corresponds to a non-limiting deployment context and does not restrict the system to underwater operation unless expressly recited in a dependent claim.

The system exists as a memory-governed structural domain in which system behavior corresponds only to admissible structural participation of structured memory entities within a system memory domain. Representations originating from underwater communication carriers do not constitute system behavior and exist only as candidate participation constructs subject to admissibility correspondence within said system memory domain. The system memory domain exists as a structured portion of physical memory and defines admissibility conditions, relational states, structural participation forms, and memory-formed boundary constraints. Said structural boundary corresponds to relationships maintained within memory independent of execution logic, routing logic, protocol-dependent determination, or communication-layer properties. System behavior does not correspond to communication outcome, signal quality, routing path, or protocol selection, and exists only upon admissible structural participation of structured memory entities. Said admissibility correspondence does not correspond to filtering, scoring, prioritization, classification, or decision-making, but corresponds solely to structural existence conditions defined within said system memory domain. Said system memory domain exists as a structured portion of physical memory within said physical computing system.

Representations originating from heterogeneous underwater communication carriers correspond to governed fact expression structures. Said correspondence does not represent semantic interpretation, classification, or algorithmic inference, but corresponds to structural alignment with admissible forms capable of participation within the system memory domain. Governed fact expression structures exist independent of communication carrier type, transmission medium, signal format, encoding method, or modeling representation. The correspondence enables cross-carrier structural comparability without reliance on communication-layer properties and establishes a unified structural basis for admissibility correspondence.

Governed fact expression structures correspond to structured memory entities within the system memory domain. Each structured memory entity exists as a structural identity associated with at least one relational state corresponding to other memory entities and exists with participation eligibility subject to admissibility conditions. Structured memory entities do not constitute executable instructions, control commands, or procedural directives, and exist only as participation-capable structures within memory. Minimal validated operational structures correspond to the smallest admissible participation units capable of contributing to system behavior constitution. The transformation structure, implemented by said at least one processor, corresponds to structural correspondence between representation structures, governed fact expression structures, and structured memory entity domains, and does not constitute a sequential processing mechanism.

Admissibility correspondence exists based on structural conditions including stored structural relationships, validated memory states, cross-carrier representation correspondence, and memory-formed constraints. Said correspondence does not represent decision-making, optimization, scoring, or evaluation procedures, but corresponds to structural alignment between candidate memory entities and admissibility conditions defined within the system memory domain. Representations or entities lacking admissibility correspondence do not exist as participating structures and therefore do not contribute to system behavior.

No individual underwater communication carrier determines system behavior. The system exists independent of acoustic communication conditions, optical transmission quality, electromagnetic propagation characteristics, routing mechanisms, or protocol implementations. Failure, degradation, or absence of any individual carrier does not by itself determine system behavior constitution. Cross-carrier correspondence exists as a structural validation condition and does not correspond to redundancy, fallback mechanisms, or communication-layer compensation.

System behavior corresponds only to admissible structural participation of structured memory entities within the system memory domain. Said behavior corresponds to physical device control, signal transmission initiation, measurable system state change, or interaction with external physical systems. No behavior exists outside admissible participation within the system memory domain, and no communication-derived representation independently constitutes behavior.

Participation history of structured memory entities exists within a lineage structure. Said lineage structure corresponds to structural participation relationships, admissibility history, and evolution of memory states. Lineage exists as part of the system memory domain and contributes to admissibility conditions by preserving structural continuity across participation events. Said lineage structure corresponds to participation history of structured memory entities as recited in the claims.

In a contested multi-domain underwater environment, a plurality of heterogeneous communication carriers exists, including acoustic, optical, and electromagnetic carriers, each corresponding to representations existing from distributed sensing and communication sources under conditions of interference, signal denial, environmental distortion, and adversarial disruption. Said representations correspond to governed fact expression structures independent of carrier reliability, transmission success, signal integrity, or environmental stability. Structured memory entities exist corresponding to said governed fact expression structures within a system memory domain. Admissibility correspondence exists only where said structured memory entities align with structural relationships, validated memory states, cross-carrier correspondence, and memory-formed constraints corresponding to admissibility conditions within said system memory domain. Representations originating from degraded, denied, or adversarial carriers do not exist as admissible participating structures in absence of structural correspondence. System behavior corresponds only to admissible structural participation of said structured memory entities and does not correspond to communication success, signal confidence, carrier priority, or operational assumptions.

In a multi-source acoustic interference environment, a plurality of acoustic carriers exists corresponding to overlapping pressure wave fields originating from multiple independent or correlated physical sources within a shared propagation medium. Representations exist corresponding to interference patterns, phase distortions, and amplitude variations. Said representations correspond to governed fact expression structures independent of noise level, signal strength, or propagation clarity. Structured memory entities exist corresponding to said representations, wherein said entities correspond to structural relationships defined within the system memory domain. Admissibility correspondence exists only where said structured memory entities align with stored relational constraints and memory-formed boundary conditions. Representations corresponding to high-intensity or high-confidence signals that lack structural correspondence do not exist as admissible participation. System behavior corresponds only to admissible structural participation and does not correspond to acoustic signal dominance, detection confidence, or environmental clarity.

In an optical observation environment characterized by scattering, absorption, and partial occlusion, representations exist corresponding to visual structures of a physical environment in which visibility is incomplete or degraded. Said representations correspond to governed fact expression structures independent of completeness, resolution, or optical fidelity. Structured memory entities exist corresponding to said partial observation structures. Admissibility correspondence exists where said structures align with relational compatibility and admissibility conditions within the system memory domain despite incomplete observation. Representations lacking completeness do not preclude admissibility where structural correspondence exists. System behavior corresponds only to admissible structural participation independent of visual completeness or optical quality.

In a cross-carrier temporal asynchrony environment, representations exist corresponding to distinct temporal instances due to propagation delay, asynchronous sensing, or distributed observation timing. Said representations correspond to governed fact expression structures independent of temporal ordering, synchronization, or latency. Structured memory entities exist corresponding to temporally distributed representations. Admissibility correspondence exists where structural relationships align across said entities independent of time of occurrence. Temporal misalignment does not affect admissibility correspondence where structural compatibility exists. System behavior corresponds only to admissible structural participation independent of synchronization or temporal sequencing.

In an adversarial mimicry environment, representations exist corresponding to patterns intentionally structured to resemble admissible configurations. Said representations correspond to governed fact expression structures and exhibit superficial structural similarity to previously admissible configurations. Structured memory entities exist corresponding to said representations. Admissibility correspondence exists only where deeper structural constraints, relational dependencies, and memory-formed boundary conditions within the system memory domain are satisfied. Representations that structurally mimic admissible patterns at a superficial level but lack deeper structural correspondence do not exist as admissible participating structures. Said representations do not correspond to system behavior despite resemblance or similarity. System behavior corresponds only to admissible structural participation and does not correspond to pattern similarity, statistical proximity, or mimicry.

In a multi-carrier structural conflict environment, representations exist corresponding to structurally inconsistent interpretations of a shared environment. Said representations correspond to governed fact expression structures independent of carrier origin or signal characteristics. Structured memory entities exist corresponding to each representation. Admissibility correspondence exists independently for each entity based on structural alignment with admissibility conditions defined within the system memory domain. Representations corresponding to conflicting interpretations do not require resolution, arbitration, prioritization, or selection. Structured memory entities lacking admissibility correspondence do not exist as participating structures. System behavior corresponds only to admissible structural participation and does not correspond to conflict resolution, voting mechanisms, or decision processes.

In a carrier degradation and denial environment, representations exist corresponding to degraded communication conditions across acoustic, optical, and electromagnetic carriers. Said representations correspond to governed fact expression structures independent of signal fidelity or degradation level. Structured memory entities exist corresponding to said degraded representations. Admissibility correspondence exists based on structural compatibility with memory-formed constraints independent of communication quality. System behavior corresponds only to admissible structural participation independent of degradation, denial, or signal loss conditions.

In a large-scale distributed multi-node environment, representations exist corresponding to distributed sensing and communication structures across a plurality of nodes. Said representations correspond to governed fact expression structures independent of node identity, geographic distribution, communication pathway, or network topology. Structured memory entities exist corresponding to distributed representations within a unified system memory domain. Admissibility correspondence exists across said distributed entities based on structural alignment independent of network configuration or routing structure. System behavior corresponds only to admissible structural participation across distributed memory entities and does not correspond to centralized coordination, routing hierarchy, or communication topology.

In a dynamic environment with evolving structural states, structured memory entities exist corresponding to admissible participation across temporal evolution. Said entities correspond to evolving relational states within the system memory domain. A lineage structure exists corresponding to participation history, structural continuity, and admissibility evolution across said entities. Admissibility correspondence exists based on both current structural alignment and lineage-derived constraints within the system memory domain. System behavior corresponds to admissible structural participation consistent with structural continuity and does not correspond to transient representations or instantaneous communication conditions.

In a physical system interaction environment, structured memory entities exist corresponding to admissible participation within the system memory domain. Said admissible participation corresponds to system behavior existing as physical device control, signal transmission initiation, measurable system state change, or interaction with external physical systems. Said behavior does not correspond to any direct communication signal, carrier output, or representation originating from any communication carrier. No communication-derived representation independently determines said behavior. System behavior exists only as a result of admissible structural participation within the system memory domain.

The system constitutes a memory-governed structural domain in which communication participation does not determine behavior, and wherein behavior exists only upon admissible structural participation of structured memory entities independent of communication carriers, transmission conditions, routing mechanisms, or protocol implementations.

1. A system, wherein system behavior corresponding to communication participation in a physical environment is constituted through admissible structural participation of structured memory entities rather than through communication outcome, routing, protocol selection, or transmission success, the system comprising:
a physical computing system comprising at least one processor and at least one memory;
a system memory domain stored within the at least one memory, wherein admissibility conditions corresponding to allowable fact expressions, relational states, structural participation forms, and memory-formed boundary constraints exist, wherein the system memory domain is implemented as a structured portion of at least one physical memory;
at least one communication carrier, including heterogeneous communication carriers;
a transformation structure implemented by at least one processor and configured to:
(i) receive representations originating from the at least one communication carrier;
(ii) normalize the representations into governed fact expressions constituting admissible structural representation forms, independent of semantic interpretation or algorithmic inference; and
(iii) convert the governed fact expressions into structured memory entities including minimal validated operational structures corresponding to smallest admissible participation units capable of participation within the system memory domain;
wherein the governed fact expressions correspond to normalized representations conforming to admissibility conditions and structural boundary constraints within the system memory domain;
a validation structure implemented by at least one processor and configured to determine correspondence based on structural alignment with at least one of stored structural relationships, validated memory states, cross-carrier representation consistency, or memory-formed constraints;
wherein the structured memory entities are admitted for storage, update, retrieval, or access as participating structures within at least one physical memory only upon correspondence to admissibility conditions;
wherein representations originating from the at least one communication carrier are excluded from participation in absence of admissibility correspondence;
wherein no individual communication carrier, transmission condition, routing mechanism, protocol, communication success, or representation origin determines system behavior;
wherein the normalization and the admissibility correspondence correspond to structural validation of representations irrespective of naming, modeling, algorithmic interpretation, or implementation form;
wherein system behavior exists only upon admissible structural participation of the structured memory entities within the system memory domain;
wherein the system behavior corresponds to at least one of physical device control, signal transmission initiation, measurable system state change, or interaction with an external physical system within a physical environment;
wherein the system behavior is constituted independent of communication-layer performance characteristics;
wherein the recited configured functions define structural correspondence relationships and do not require a fixed operational sequence;
wherein admissibility correspondence is independent of probability, scoring, prioritization, or confidence measures.

2. The system of claim 1, wherein the physical environment comprises an underwater environment.

3. The system of claim 1, wherein the communication carrier is configured for operation in an underwater environment including at least one of acoustic communication, optical communication, or electromagnetic communication.

4. The system of claim 3, wherein the acoustic communication comprises propagation through pressure-based wave transmission within a fluid medium.

5. The system of claim 3, wherein the optical communication comprises transmission through blue or green wavelength light within a water medium.

6. The system of claim 3, wherein the electromagnetic communication comprises low-frequency or very low-frequency transmission capable of propagation through water.

7. The system of claim 1, wherein the communication carrier is further configurable to include future or non-classical communication channels, including quantum communication channels, when structurally represented as communication carriers under the system memory domain.

8. The system of claim 1, wherein the transformation structure performs normalization of heterogeneous representations into the governed fact expressions independent of carrier type, transmission medium, or signal format.

9. The system of claim 1, wherein the validation structure evaluates admissibility correspondence based on cross-carrier consistency, structural compatibility, and memory-derived constraints.

10. The system of claim 1, wherein representations originating from the communication carriers do not constitute command, control, intelligence, or system action in absence of the admissibility correspondence.

11. A method for constituting system behavior corresponding to communication participation in a physical environment, wherein the system behavior is not determined based on communication outcome, routing, protocol selection, or transmission success, and wherein no individual communication carrier determines the system behavior, the method comprising:
receiving representations corresponding to reception from at least one communication carrier;
normalizing the representations into governed fact expressions corresponding to admissibility conditions within a system memory domain;
forming structured memory entities corresponding to governed fact expressions, including minimal validated operational structures capable of participation;
associating the structured memory entities with admissibility evaluation based on structural relationships, validated memory states, cross-carrier representation consistency, or memory-formed constraints within the system memory domain;
the structured memory entities corresponding to storage, update, retrieval, and access within a physical memory system comprising the system memory domain only upon correspondence to the admissibility conditions;
and constituting system behavior through admissible structural participation of the structured memory entities within the system memory domain;
wherein the system behavior corresponds to at least one of physical device control, signal transmission initiation, measurable system state change, or interaction with an external physical system;
wherein the method defines structural admissibility correspondence and does not require behavior determination by procedural execution logic.

12. The method of claim 11, wherein the communication carrier operates in an underwater environment.

13. The method of claim 11, wherein a plurality of heterogeneous communication carriers participate concurrently.

14. The method of claim 11, wherein admissibility correspondence is evaluated based on cross-carrier representation consistency.

15. The method of claim 11, wherein representations originating from the communication carriers do not independently constitute system behavior.

16. The method of claim 11, wherein failure or degradation of any individual communication carrier does not determine system behavior.

17. The method of claim 11, further comprising a lineage structure corresponding to participation history, structural continuity, admissibility history, and reconstructable consistency within a system memory domain.

18. A non-transitory computer-readable medium storing instructions which, when executed within a physical computing system comprising at least one processor and memory, cause the system to:
receive representations originating from at least one communication carrier;
normalize the representations into governed fact expressions corresponding to admissibility conditions within a system memory domain;
convert the governed fact expressions into structured memory entities including minimal validated operational structures;
evaluate the structured memory entities for admissibility correspondence based on structural relationships, validated memory states, cross-carrier consistency, or memory-derived constraints within the system memory domain;
store, update, retrieve, and access the structured memory entities within a physical memory system comprising the system memory domain only upon correspondence to the admissibility conditions;
exclude representations lacking admissibility correspondence;
constitute system behavior only upon admissible structural participation of the structured memory entities;
wherein the system behavior corresponds to at least one of physical device control, signal transmission initiation, measurable system state change, or interaction with an external physical system;
wherein the recited instructions define structural correspondence conditions and do not require a fixed execution sequence unless required by implementation;
wherein the instructions implement structural admissibility correspondence without requiring behavior determination by procedural execution logic.

19. The medium of claim 18, wherein the instructions further cause evaluation based on cross-carrier representation consistency.

20. The medium of claim 18, wherein the instructions further cause, in combination, participation of representations originating from multiple heterogeneous carriers, exclusion of representations lacking admissibility correspondence, recording of lineage corresponding to participation history, structural continuity, admissibility history, and reconstructable consistency within the system memory domain.
